(19) United States
(12) Patent Application Publication
(10) Pub. No.: US 2014/0214637 A1
(43) Pub. Date: Jul. 31, 2014

(54) DETERMINING LOCAL CALCULATION CONFIGURATIONS IN AN ACCOUNTING APPLICATION THROUGH USER CONTRIBUTION

(71) Applicant: Yogish Pai, Santa Clara, CA (US)

(72) Inventor: Yogish Pai, Santa Clara, CA (US)

(21) Appl. No.: 13/756,037

(22) Filed: Jan. 31, 2013

(51) Int. Cl. G06Q 40/00

(52) U.S. Cl. CPC G06Q 40/103
USPC 705/31

(57) ABSTRACT

A method to generate a suggested calculation configuration in a software application for a geographical region. The method includes calculation configurations generated by users according to a regulatory requirement of the geographical region, generating a statistical measure of the users and a number of times a task is performed by the users using the calculation configurations, generating, in response to the statistical measure exceeding a threshold, a suggested calculation configuration to represent the calculation configurations, and presenting, in response to at least determining that a new user of the software application is within the geographical region, the suggested calculation configuration to the new user, where the suggested calculation configuration is used by the new user to configure a new instantiation of the software application for performing the task within the geographical region.

### SUMMARY

In general, in one aspect, the invention relates to a method to generate a suggested calculation configuration in a software application for a geographical region. The method includes obtaining a plurality of calculation configurations generated by a plurality of users according to a regulatory requirement of the geographical region, wherein each of the plurality of calculation configurations comprises a configuration entry that is used by the plurality of users to configure a plurality of instantiations of the software application for performing a pre-determined task, and wherein performing the pre-determined task within the geographical region comprises at least calculating a result based on the configuration entry, generating, by a computer processor, a statistical measure of the plurality of users and a number of times the pre-determined task is performed by the plurality of users, generating, by the computer processor and in response to the statistical measure exceeding a pre-determined threshold, a suggested calculation configuration to represent the plurality of calculation configurations, and presenting, in response to at least determining that a new user of the software application is within the geographical region, the suggested calculation configuration to the new user, wherein the suggested calculation configuration is used by the new user to configure a new instantiation of the software application for performing the pre-determined task within the geographical region.

In general, in one aspect, the invention relates to a system to generate a suggested calculation configuration in a software application for a geographical region. The system includes (i) a computer processor, (ii) a calculation configuration analyzer executing on the computer processor and configured to obtain a plurality of calculation configurations generated by a plurality of users according to a regulatory requirement of the geographical region, wherein each of the plurality of calculation configurations comprises a configuration entry that is used by the plurality of users to configure a plurality of instantiations of the software application for performing a pre-determined task, and wherein performing the pre-determined task within the geographical region comprises at least calculating a result based on the configuration entry, generate a statistical measure of the plurality of users and a number of times the pre-determined task is performed by the plurality of users, generate, in response to the statistical measure exceeding a pre-determined threshold, a suggested calculation configuration to represent the plurality of calculation configurations, (iii) a user device coupled to the computer processor and configured to present, in response to at least determining that a new user of the software application is within the geographical region, the suggested calculation configuration to the new user, wherein the suggested calculation configuration is used by the new user to configure a new instantiation of the software application for performing the pre-determined task within the geographical region, and (iv) a repository configured to store the statistical measure and the suggested calculation configuration.

In general, in one aspect, the invention relates to a non-transitory computer readable medium storing instructions to generate a suggested calculation configuration in a software application for a geographical region. The instructions, when executed by a computer processor, comprising functionality for obtaining a plurality of calculation configurations generated by a plurality of users according to a regulatory requirement of the geographical region, wherein each of the plurality of calculation configurations comprises a configuration entry that is used by the plurality of users to configure a plurality of instantiations of the software application for performing a pre-determined task, and wherein performing the pre-determined task within the geographical region comprises at least calculating a result based on the configuration entry, generating, by a computer processor, a statistical measure of the plurality of users and a number of times the pre-determined task is performed by the plurality of users, generating, by the computer processor and in response to the statistical measure exceeding a pre-determined threshold, a suggested calculation configuration to represent the plurality of calculation configurations, and presenting, in response to at least determining that a new user of the software application is within the geographical region, the suggested calculation configuration to the new user, wherein the suggested calculation configuration is used by the new user to configure a new instantiation of the software application for performing the pre-determined task within the geographical region.

Other aspects of the invention will be apparent from the following detailed description and the appended claims.

### BRIEF DESCRIPTION OF DRAWINGS

FIGS. 1A-1B show schematic diagrams of a system of determining local calculation configurations in an accounting application through user contribution in accordance with one or more embodiments of the invention.

FIG. 2 shows a flowchart of a method of determining local calculation configurations in an accounting application through user contribution in accordance with one or more embodiments of the invention.

FIGS. 3A-3C show an example of determining local calculation configurations in an accounting application through user contribution in accordance with one or more embodiments of the invention.

FIG. 4 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Payroll tax generally refers to two different kinds of taxes. The first kind is a withholding tax that employers are required to withhold from employees' wages, typically covering advance payment of income tax and social security contributions. The second kind is a tax that is paid from the employer's own funds, for example covering the employer's funding of the social security system.

Federal, state, and local withholding taxes are required in those tax jurisdictions imposing an income tax. These taxes are computed on various compensation bases, and are collected and paid to the taxing jurisdiction by the employers. Employers having contact with the jurisdiction must withhold the tax from wages paid to their employees in those jurisdictions. Computation of the amount of tax to withhold is performed based on the employer's tax status. Tax jurisdictions typically require payroll tax reporting on quarterly or annual schedules.

In computing, the terms “internationalization” and “localization” refer to adapting computer software to different languages, regional differences and regulatory requirements of a target market. Internationalization is the process of designing a software application so that the application can be adapted to various regional requirements without substantial engineering changes. Localization is the process of adapting internationalized software for a specific region by adding locale-specific components and translating text based on a language specific to the region. Throughout this disclosure, the term “tax jurisdiction” or “jurisdiction” refers to a region with a set of tax laws under the control of a system of courts or government entity which are different to neighboring regions.

A social network is a social structure (e.g., community) made of members (e.g., a person) connected by social relationships such as friendship, kinship, relationships of beliefs, knowledge, prestige, culture, etc. Members of a social network often share interests and activities relating to such social relationships. For example, individual computers linked electronically could form the basis of computer mediated social interaction and networking within a social network community. A social network service focuses on building online communities of people who share interests and/or activities, or who are interested in exploring the interests and activities of others. Most social network services are message based and provide a variety of ways (e.g., e-mail, instant messaging service, etc.) for users (or members) to interact socially via social network messages. Examples of computer mediated social network services include Facebook® (a registered trademark of Facebook, Inc., Palo Alto, Calif.), Myspace® (a registered trademark of Myspace, Inc., Beverly Hills, Calif.), Twitter® (a registered trademark of Twitter, Inc., San Francisco, Calif.), Linkedln® (a registered trademark of Linkedln, Ltd., Mountain View, Calif.), etc. Certain social network services provide application programming interface allowing programmatic access to retrieve social network messages.

Embodiments of the invention provide suggested calculation configurations in an accounting software through user contribution. In one or more embodiments, the account software resides on a computer server and includes payroll functionality to calculate payroll deductions and payroll taxes. For example, the payroll deductions may include pre-tax deduction, tax deduction, and post-tax deduction that are deducted from a gross wage amount to calculate a net amount of a payroll check for an employee. Such calculations are based on the calculation configuration that is set up within an instantiation of the software application by the user of the particular instantiation. For example, the user may set up the calculation configuration by manually creating and/or editing a calculation configuration data structure (e.g., file, database, etc.), e.g., via a graphical user interface of the accounting application. In another example, the user may set up the calculation configuration by installing the calculation configuration data structure of the accounting application instantiation from a shared repository.

In one or more embodiments of the invention, user created calculation configurations are stored in the shared repository where a statistical pattern is identified from common (i.e., popular) user created calculation configurations. For example, the user created calculation configuration may include numeric data representing percentages, maximum/minimum thresholds, etc. of calculation rules where each calculation rule may further include descriptive data. In this example, the statistical pattern may represent a pattern of the numeric data that is common in many user created calculation configurations while the corresponding descriptive data may be user specific and vary from user to user. In one or more embodiments, a suggested calculation configuration is generated based on the statistical pattern using system generated descriptive data to represent corresponding user specific descriptive data.

In one or more embodiments of the invention, the suggested calculation configuration is presented to a new user for use in setting up his/her instantiation of the accounting software. A user may also recommend a particular calculation configuration to the other user by sending a message, such as email, text message, social network message, etc. A user who has distributed any calculation configuration recommendation or whose calculation configuration has contributed to the statistical pattern is referred to as a contributing user. A user who has adopted any calculation configuration recommendation or whose calculation configuration is derived from the statistical pattern is referred to as an adopting user. The contributing users and the adopting users form a user network via the computer server and the shared repository, as well as other messaging network, such as email network, text message network, social network, etc. In one or more embodiments, an alert is sent to the adopting users when a contributing user in the user network revises his/her calculation configuration, on which the adopting user's calculation configuration may be based.

In one or more embodiments of the invention, the suggested calculation configurations are generated based on statistical measures of users, including the contributing users and the adopting users. The statistical measures may include number of registered (paid) users, number of active users, number of active users whose calculation configurations match a particular pattern, number of payroll cycles generated by the accounting application using a calculation configuration that matches a particular pattern, etc.

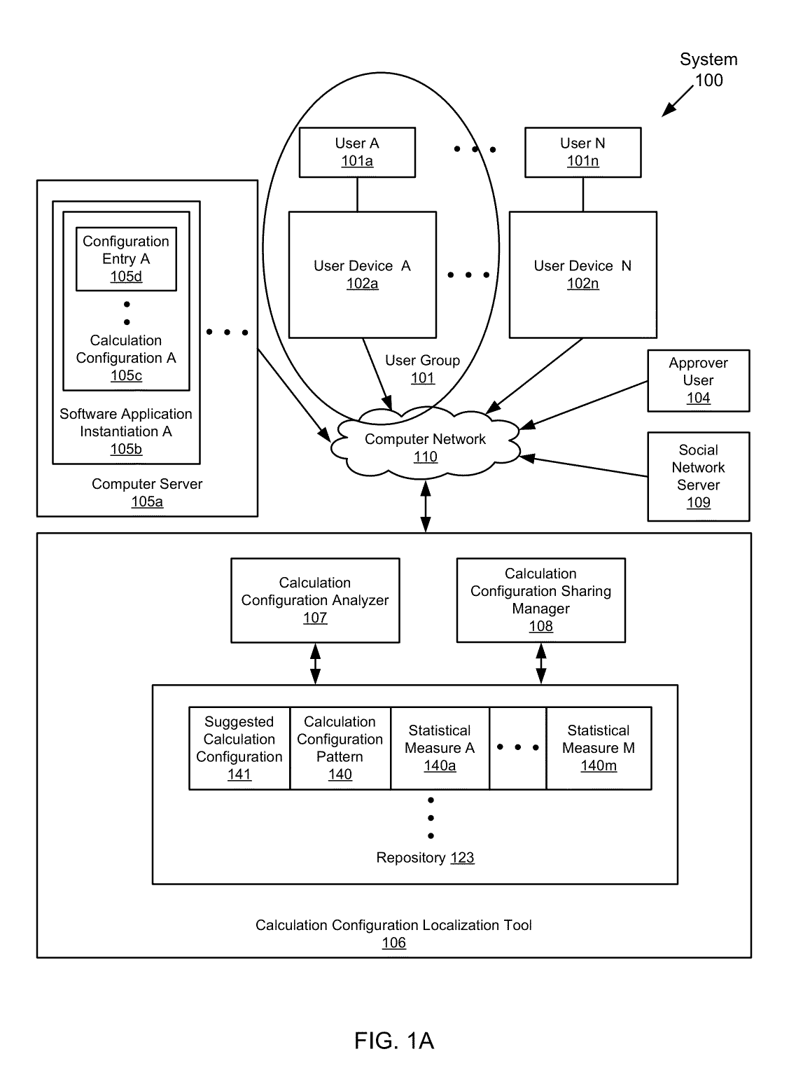

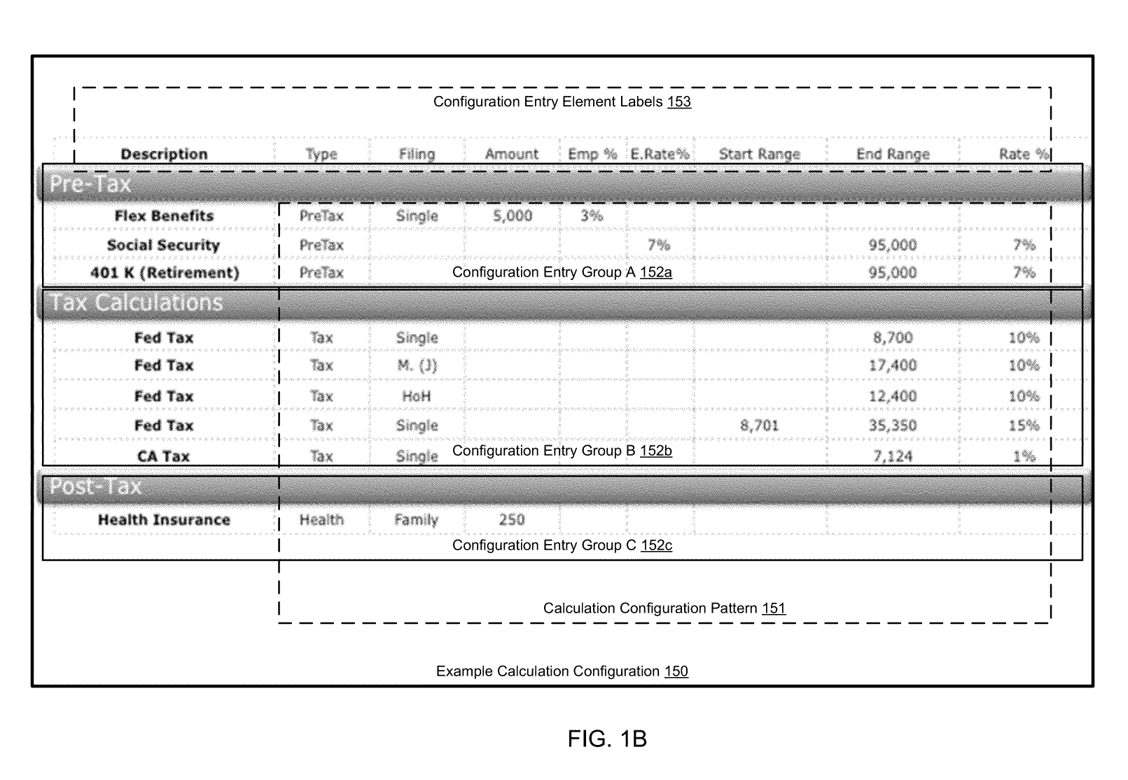

FIG. 1A depicts a schematic block diagram of a system (100) in accordance with one or more embodiments of the invention. In one or more embodiments of the invention, one or more of the modules and elements shown in FIG. 1A may be omitted, repeated, and/or substituted. Accordingly, embodiments of the invention should not be considered limited to the specific arrangements of modules shown in FIG. 1A.

As shown in FIG. 1A, the system (100) includes a computer server (105a) executing software application instantiations (e.g., software application instantiation A (105b), etc.) each includes a calculation configuration (e.g., calculation configuration A (105c)) storing a configuration entry (e.g., configuration entry A (105d)). In one or more embodiments, the calculation configuration (e.g., calculation configuration A (105c)) may be a data file, a linked list, a data sequence, a database, a graphical representation, or any other suitable data structure stored in a repository (not shown) in the computer server (105a). An example of the calculation configuration and configuration entries is shown in FIG. 1B below. The software application instantiations (e.g., software application instantiation A (105b), etc.) may be copies of an accounting software, financial software, a web service, or any other online software product. The software application instantiation (105b) may also be a desktop application/product. In addition, each of the users (e.g., user A (101a), user N (101n), etc.) launches the software application to execute one of the software application instantiations (e.g., software application instantiation A (105b), etc.) using respective user devices (e.g., user device A (102a), user device N (102n), etc.). In one or more embodiments, the user devices (e.g., user device A (102a), user device N (102n), etc.) may be a desktop computer, notebook computer, tablet computer, or other suitable mobile computing devices such as a smartphone.

In one or more embodiments, the software application instantiation A (105b) is a web based application such that the users (e.g., user A (101a), user N (101n), etc.) interacts with the software application instantiations (e.g., software application instantiation A (105b), etc.) using web browsers on respective user devices (e.g., user device A (102a), user device N (102n), etc.). In one or more embodiments, an instantiation of the software application (e.g., software application instantiation A (105b)) is downloaded onto a user device (e.g., user device A (102a)) where a user (e.g., user A (101a)) interacts with the downloaded instantiation of the software application via a UI menu displayed on the user device (e.g., user device A (102a)).

In one or more embodiments, each of the calculation configurations (e.g., calculation configuration A (105c)) is created and/or used by one or more users (e.g., user group (101)) to configure a corresponding instantiation of the software application (e.g., software application instantiation A (105b)) for performing a pre-determined task. For example, the pre-determined task may include payroll processing, accounting report, tax filing, etc. according to regulatory requirements of a particular geographical region. Generally, the regulatory requirements are specific to a particular tax jurisdiction, labor law jurisdiction, or other regulatory agency jurisdictions. In particular, performing the pre-determined task within the geographical region may include at least calculating a deduction amount (e.g., a pre-tax deduction amount, a tax withholding amount, a post-tax deduction amount, etc.) based on the configuration entry (e.g., configuration entry A (105d)).

Some users (e.g., user A (101a),) may be members of a user group (e.g., user group (101). A user group may be, for example, a group of accountants working in the particular geographical region who jointly contribute to localization of the software application such that the resultant localized version of the software application is shared within the user group. Alternatively, in one or more embodiments of the invention, a user group or individual users may be tax experts wanting to configure calculation configurations and use such calculation configurations to advertise services in each geographic region. For example, the user A (101a) of a particular geographical region (e.g., a country) may have launched an execution of the software application instantiation A (105b) and created the calculation configuration A (105c) including the configuration entry A (105d) according to regulatory requirements (e.g., tax jurisdiction requirements) of the particular geographical region. Accordingly, the calculation configuration A (105c) is included as an input contributing to a suggested calculation configuration (e.g., suggested calculation configuration (141)) for the particular geographical region. For example, the suggested calculation configuration may be presented to a new user (e.g., user N (101n) who may use the suggestion to process payroll, prepare an accounting report, prepare a tax agency filing, or perform another suitable pre-determined task within the particular geographical region. Generally, the user group (101) includes the aforementioned contributing users and adopting users.

FIG. 1B shows an example of calculation configurations, such as the example calculation configuration (150) in accordance with one or more embodiments of the invention. In particular, the example calculation configuration (150) may be an example of the calculation configuration A (105C) or an example of the suggested calculation configuration (141) as depicted in FIG. 1A above. In one or more embodiments of the invention, one or more of the modules and elements shown in FIG. 1B may be omitted, repeated, and/or substituted. Accordingly, embodiments of the invention should not be considered limited to the specific arrangements of modules shown in FIG. 1B.

As shown in FIG. 1B, the example calculation configuration (150) includes three portions, namely the configuration entry group A (152a) having configuration rules for calculating pre-tax deductions, the configuration entry group B (152b) having calculation rules for calculating tax deductions, and the configuration entry group C (152c) having configuration rules for calculating post-tax deductions. Specifically, the example calculation configuration (150) is a table of multiple rows where each row is a calculation configuration entry having one or more configuration entry elements labeled using the configuration entry element labels (153). In particular, the configuration entry element labels (153) assign a label to each column of the example calculation configuration (150). In one or more embodiments, the label for each column in the configuration entry element labels (153) is pre-defined in the software application.

For example, the top row of the example calculation configuration (150) is a calculation configuration entry that includes five configuration entry elements, namely “Flex Benefits,” “PreTax,” “Single,” “5,000,” and “3%” that are labeled as “Description,” “Type,” “Filing,” “Amount,” and “Emp %,” respectively. Specifically, this configuration entry describes a calculation rule to calculate a pre-tax deduction for flexible benefits based on single filing status using an employer contribution percentage of 3% and maximum amount of $5,000. In another example, the second column of the example calculation configuration (150) is labeled “Type” and specifies the type of each calculation rule in a row. In one or more embodiments, those configuration entries having the “PreTax” type are grouped into the configuration Entry Group A (152a). Further, those configuration entries having the “Tax” type are grouped into the configuration Entry Group B (152b). Lastly, the remaining configuration entries are grouped into the configuration Entry Group C (152c).

In one or more embodiments, the example calculation configuration (150) is created by a user. In such embodiments, the configuration entry elements in some columns (e.g., “Amount,” “Emp %,” “E.Rate %,” “Start Range,” “End Range,” and “Rate %” columns) are numeric data entered by the user to represent percentages (e.g., 3%, 7%, etc.), maximum/minimum thresholds (e.g., 5,000, 95,000, etc.), etc. of the calculation rules. The configuration entry elements in some other columns (e.g., “Type” and “Filing” columns) are pre-defined text strings (e.g., PreTax, Tax, Single, Health, Family, etc.) that are pre-defined in the software application and specified by a user from a selection menu of the software application. In addition, the configuration entry elements in the “Description” column are free form text strings (e.g., Flex Benefits, etc.) entered by the user to name (i.e., describe) the calculation rules. In one or more embodiments, other columns may also contain free form text strings entered by the user to represent user specified non-quantitative attributes (not shown) of the calculation rules. Each user has the discretion to input a particular wording to describe the name or other non-quantitative attributes of the calculation rules. In other words, free form text strings inputted by different users to describe the same calculation rule or non-quantitative attribute, although semantically equivalent, may have different wordings. For example, text strings “Flex Benefits” and “Flexible Benefit,” defined by two users are semantically equivalent but have different wordings.

In one or more embodiments, the user specified numeric data and the user selections of pre-defined text strings form a user specific calculation configuration pattern (e.g., calculation configuration pattern (151)) of the calculation configuration (e.g., example calculation configuration (150)). In particular, the user specified numeric data and the user selections of pre-defined text strings in each row of the example calculation configuration (150) form a sequence of entry elements. As shown in FIG. 1B, the calculation configuration pattern (151) includes multiple sequences of entry elements in multiple rows of the example calculation configuration (150). For example, the calculation configuration pattern (151) includes the sequences: (PreTax, Single, 5,000, 3%), (PreTax, 7%, 95,000, 7%), etc. Generally, a calculation rule is defined by at least the sequence of user specified numeric data and the user selections of pre-defined text strings. In certain scenarios, different calculation rules may have the same sequence of entry elements. In one or more embodiments, some user entered free form text strings are analyzed semantically and further included in the calculation configuration pattern (151). For example, in some embodiments, the “Type” column or the “Filing” column may contain user entered free form text strings instead of user selections of pre-defined text strings. In such embodiments, the sequence of entry elements are based on the “Amount,” “Emp %,” “E.Rate %,” “Start Range,” “End Range,” and “Rate %” columns. In addition, fuzzy logic technique or neural network technique may be used to identify patterns in the “Description” column as well as the “Type” and/or “Filing column.

In one or more embodiments, the example calculation configuration (150) is a suggested calculation configuration (e.g., the suggested calculation configuration (141) of FIG. 1A) based on a common (i.e., popular) calculation configuration pattern found in multiple users' calculation configurations. In particular, the sequences of entry elements (i.e., the user specified numeric data and user selection of pre-defined text strings) are the same throughout these multiple users' calculation configurations and are incorporated in the corresponding configuration entry elements of the suggested calculation configuration (e.g., the suggested calculation configuration (141) of FIG. 1A). Further, the “Description” columns in these multiple users' calculation configurations are analyzed to generate semantic equivalent calculation rule names by the calculation configuration localization tool (106), described below, for the suggested calculation configuration (e.g., the suggested calculation configuration (141) of FIG. 1A). For example, text strings “Flex Benefits” and “Flexible Benefit” are analyzed to generate the system defined semantic equivalent “FlexBenefit” using semantic analysis techniques known to those skilled in the art. Such semantic analysis techniques may include, but are not limited to, word cloud analysis technique, cluster analysis technique, latent semantic analysis/indexing, Latent Dirichlet allocation, etc.

Returning to the discussion of FIG. 1A, the system (100) includes a calculation configuration localization tool (106) having a calculation configuration analyzer (107), a calculation configuration sharing manager (108), and a repository (123) for storing intermediate data and resultant outputs of the calculation configuration analyzer (107) and the calculation configuration sharing manager (108). The repository (123) may include a disk drive storage device, a semiconductor storage device, other suitable computer data storage device, or combinations thereof. Various components of the system (100) are coupled via a computer network (110). For example, the computer network (110) may include wired and/or wireless portions of public and/or private data network, such as wide area networks (WANs), local area networks (LANs), Internet, etc.

In one or more embodiments of the invention, the calculation configuration analyzer (107) is configured to obtain a collection of calculation configurations (e.g., calculation configuration A (105c), etc.) generated by a group of users (e.g., user group (101)) according to a regulatory requirement of a geographical region. For example, the collection of calculation configurations (e.g., calculation configuration A (105c), etc.) may be retrieved from the computer server (105a) via an application programming interface (not shown) of each of the software application instantiations (e.g., software application instantiation A (105b), etc.). Once retrieved, the collection of calculation configurations (e.g., calculation configuration A (105c), etc.) or representative data/metadata thereof are stored in the repository (123) for use by the calculation configuration analyzer (107). In addition, usage statistics of the collection of calculation configurations (e.g., calculation configuration A (105c), etc.) for performing the pre-determined tasks by the group of users (e.g., user group (101)) are also retrieved from the computer server (105a) and stored in the repository (123). For example, a number of times the pre-determined task is performed using any one of the collection of calculation configurations (e.g., calculation configuration A (105c), etc.) by anyone of the group of users (e.g., user group (101)) may also be retrieved via the aforementioned application programming interface.

In one or more embodiments, the calculation configuration analyzer (107) is configured to generate a statistical measure (e.g., statistical measure A (140a), statistical measure M (140m), etc.) of the group of users (e.g., user group (101)) and/or a number of times the pre-determined task is performed by the group of users (e.g., user group (101)). In one or more embodiments, the calculation configuration analyzer (107) is further configured to generate, in response to the statistical measure (e.g., statistical measure A (140a), statistical measure M (140m), etc.) exceeding a pre-determined threshold (not shown), a suggested calculation configuration (e.g., suggested calculation configuration (141)) to represent a portion of the collection of calculation configurations (e.g., calculation configuration A (105c), etc.) that is qualified based on the statistical measure. In particular, the user group (101) and the qualified portion of the collection of calculation configurations generated thereby are considered statistically meaningful when the statistical measure exceeds the pre-determined threshold.

In one or more embodiments, the user device N (102n)) is configured to present the suggested calculation configuration (141) to the user N (101n), in response to at least determining that the user N (101n) is within the geographical region. Accordingly, the suggested calculation configuration (141) can be used by the user N (101n) to configure a respective instantiation of the software application for performing the pre-determined task within the geographical region. For example, the user N (101n) may be a new user of the software application who has not yet created, or otherwise configured the calculation configuration of the software application. In another example, the user N (101n) may have previously created a calculation configuration but decides to replace it by adopting the suggested calculation configuration (141).

In one or more embodiments, the calculation configuration localization tool (106) includes the calculation configuration analyzer (107) that is configured to identify the user group (101), and therefore the collection of calculation configurations generated thereby as statistically meaningful based on one or more statistical measures. In one or more embodiments, any user group that is not determined as statistically meaningful is discarded by the calculation configuration analyzer (107). Said in other words, any suggested calculation configuration is generated only from a statistically meaningful user group, such as the user group (101). In addition, the user group (101) may be further qualified based on an industry designation in a user profile of each of the users (e.g., user A (101a)). Accordingly, the resultant suggested calculation configuration (e.g., suggested calculation configuration (141)) is specific to the particular industry.

In an example, the user group (101) may be identified based on a number of rows (i.e., calculation rules) that is same for each of the calculation configurations (e.g., calculation configuration A (105c)) used by users (e.g., user A (101a)) in the user group (101). In particular, all these calculation configurations have the same number of pre-tax deduction calculation rules, same number of tax deduction calculation rules, and same number of post-tax deduction calculation rules. Said in other words, users having the same pre-tax deduction calculation rule counts, the same tax deduction calculation rule counts, and the same post-tax deduction calculation rule counts in their calculation configurations are included in the user group (101). In this example, the statistical measure A (140a) may be a number of users in the user group (101) who have performed the pre-determined task based on their calculation configurations (e.g., calculation configuration A (105c)). Said in other words, the statistical measure A (140a) is the size of the user group (101) using the same respective counts of pre-tax, tax, and post-tax deduction calculation rules. In addition, the statistical measure M (140m) may be a number of times the users in the user group (101) have performed the pre-determined task based on their calculation configurations (e.g., calculation configuration A (105c)). That is, the statistical measure M (140m) is a frequency measure of how often the calculation configurations having the same respective counts of pre-tax, tax, and post-tax deduction calculation rules are used by the user group (101). Accordingly, the suggested calculation configuration (141) may be generated when the size of the user group (101) and/or the frequency measure of using the same size calculation configurations by the user group (101) exceed a pre-determined threshold.

In yet another example, the user group (101) may be identified based on a calculation configuration pattern (e.g., calculation configuration pattern (140)) that is same for each of the calculation configurations (e.g., calculation configuration A (105c)) used by users in the user group (101). In particular, the calculation configuration pattern is a pattern of configuration entry elements in a calculation configuration. In one or more embodiments, the calculation configuration pattern (140) is based on the aforementioned user specified numeric data and user selections of pre-defined text strings in the configuration entry elements. In other words, the calculation configuration pattern (140) is based on a sequence of the entry elements, such as the user specified numeric data and user selections of pre-defined text strings. In the sequence, the entry elements are ordered the same way as the configuration entry element labels (153). Accordingly, a user group (101) may be defined by users whose calculation configurations share the same pattern. In this example, the statistical measure A (140a) may be a number of users in the user group (101) who have performed the pre-determined task based on the same calculation configuration pattern (140). In addition, the statistical measure M (140m) may be a number of times the users in the user group (101) have performed the pre-determined task based on the calculation configuration pattern (140). Said in other words, the statistical measure M (140m) is a frequency measure of how often the calculation configuration pattern (140) is used by the user group (101). Accordingly, the suggested calculation configuration (141) may be generated when the size of the user group (101) sharing the same calculation configuration pattern (140) and/or the frequency measure of using the same calculation configuration pattern (140) by the user group (101) exceed a pre-determined threshold.

In still another example, the user group (101) may be identified based on a combination of statistical measures, each exceeding a corresponding pre-determined threshold. In this example, the user group (101) is considered statistically meaningful if it has a number of registered users who have paid for the software application exceeding a first minimum user count, a number of users who have performed the pre-determined task based on the same size calculation configurations exceeding a second minimum user count, a number of users who have performed the pre-determined task based on the same calculation configuration pattern exceeding a third minimum user count, and a number of times that the users have performed the pre-determined task based on the same calculation configuration pattern exceeding a minimum number of times.

In one or more embodiments, the calculation configuration analyzer (107) is configured to analyze the collection of calculation configurations generated by the user group (101) to identify the calculation configuration pattern (140). Specifically, to identify the calculation configuration pattern (140) from the collection of calculation configurations, the calculation configuration analyzer (107) determines whether every calculation configuration in at least a portion of the collection has one or more of the following: the same number of configuration entry rows, the same number of pre-tax deduction calculation rules, the same number of tax deduction calculation rules, the same number of post-tax deduction calculation rules, and the same sequences of entry elements. In particular, having the same sequences of entry elements requires having same values of all corresponding user entered numeric data, and same user selections of all corresponding predefined text strings.

Generally, the suggested calculation configuration (141) is applicable to a particular regulatory agency jurisdiction (e.g., tax jurisdiction) of a particular geographical region. In one or more embodiments, multiple suggested calculation configurations may be generated by the calculation configuration analyzer (107) as contributed by users regulated by different tax jurisdictions in different geographical regions. For example, the calculation configuration analyzer (107) is further configured to generate other suggested calculation configurations (not shown) applicable to other tax jurisdictions in different geographical regions than the suggested calculation configuration (141). In particular, these other suggested calculation configurations are generated based on different calculation configuration patterns (not shown) than the calculation configuration pattern (140). In one or more embodiments, these different calculation configuration patterns (not shown) are derived from the same statistical measure(s) and pre-determined thresholds than those used to derive the calculation configuration pattern (140). In one or more embodiments, these different calculation configuration patterns (not shown) are derived from different statistical measure(s) and/or different pre-determined thresholds than those used to derive the calculation configuration pattern (140). Accordingly, different users in different tax jurisdiction and/or different geographical regions are presented with different suggested calculation configurations.

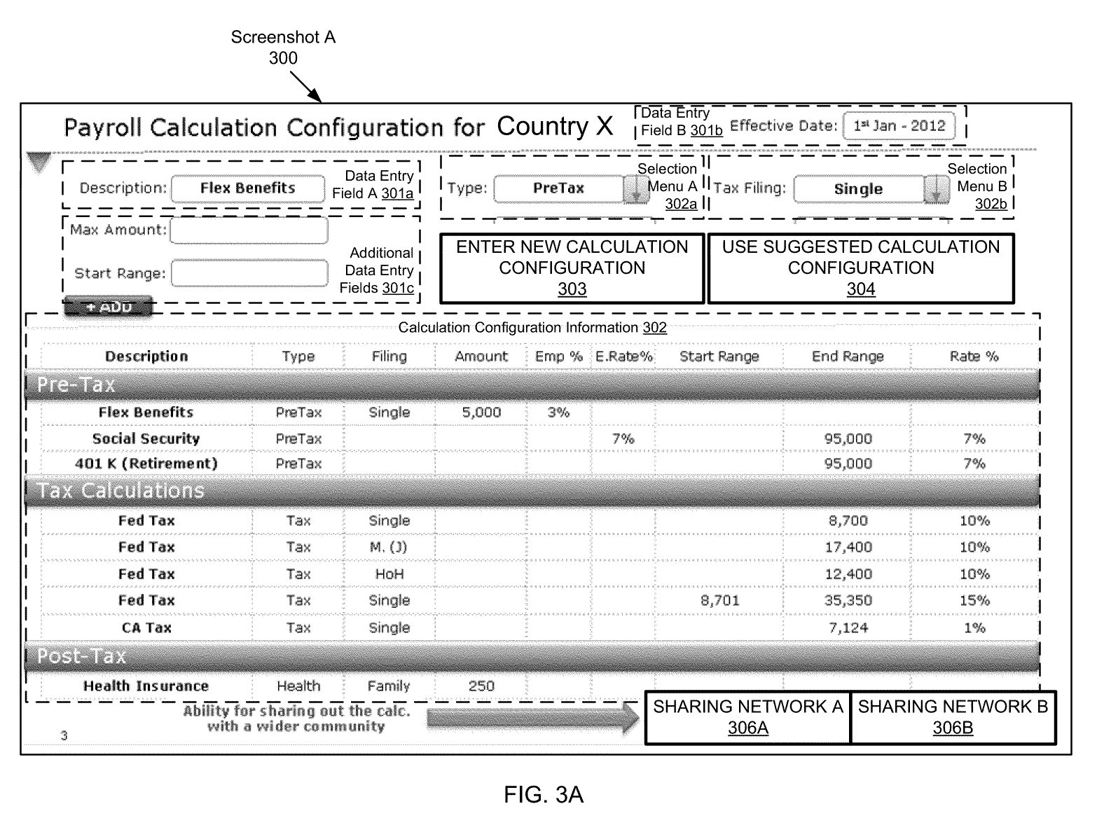

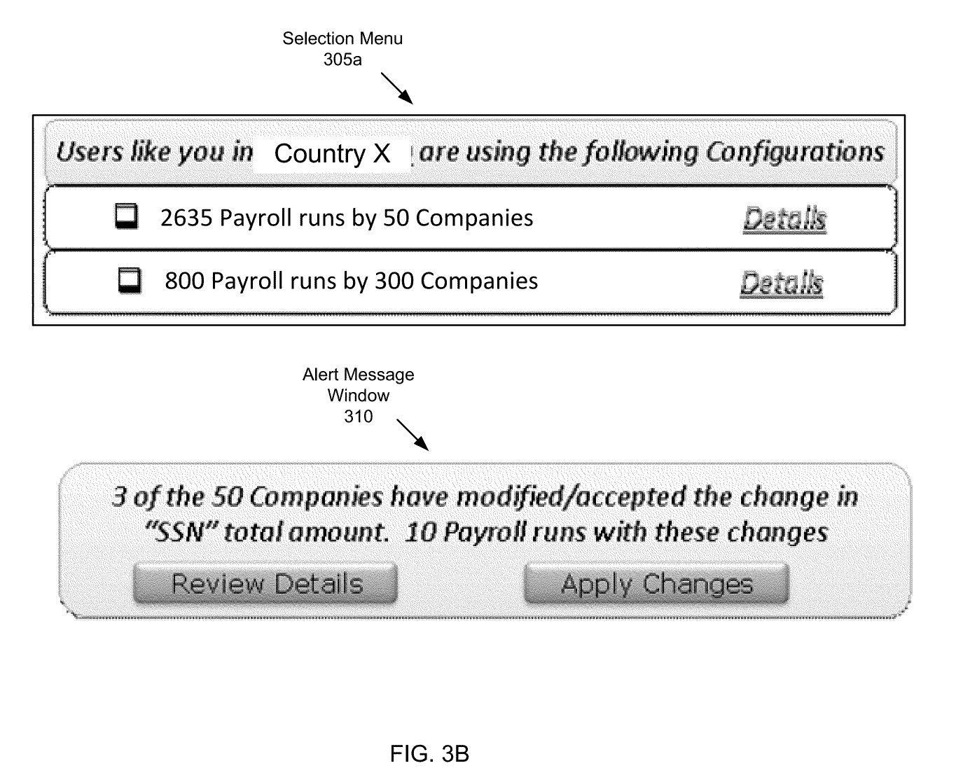

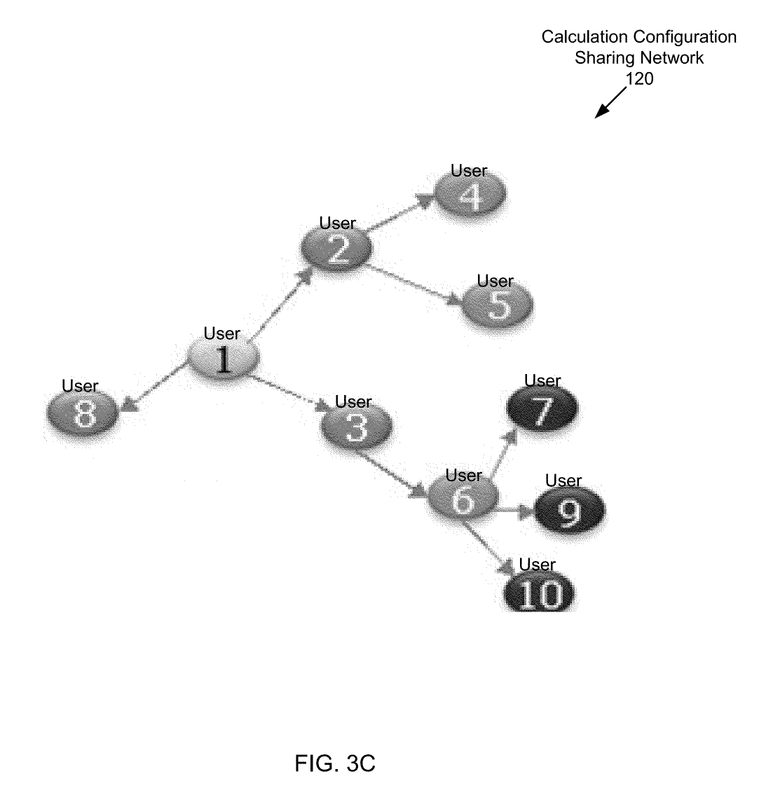

In one or more embodiments, when a new user (e.g., user N (101n)) is configuring a new instantiation of the software application, a user interface window is presented to the new user using the user device (e.g., user device N (102n)). The user interface window includes messages and input fields requesting the new user to select between manually creating a new calculation configuration or using a calculation configuration suggestion function of the software application. If the option of manually creating the new calculation configuration is selected, the user interface would request further input from the new user (e.g., user N (101n)) to generate the new calculation configuration. An example user interface window for requesting user input to generate the new calculation configuration is shown in FIG. 3A, described in detail later. If the option of using the calculation configuration suggestion is selected, the example suggested calculation configuration (141) may then be presented to the new user (e.g., user N (101n)) to be adopted. Similarly, the calculation configuration A (105c) configured in the software application instantiation A (105b) may have been previously created by the user A (101a) selecting the manual option or adopted by the user A (101a) selecting the calculation configuration suggestion function of the software application.

Generally, a user may allow his/her configuration to be captured, analyzed, and suggested to other users by the calculation configuration localization tool (106). In addition, the user may also directly recommend a calculation configuration that he/she created, adopted, or otherwise has access to. In other words, either a new user who adopted the suggested calculation configuration or a contributing user who contributed to the suggested calculation configuration may also make an explicit recommendation to another new user (i.e. a second user) who is in the process of configuring the software application. For example, the user may send a link of the recommended calculation configuration to the second user via a message, such as an email message, a SMS message, a social network message, or a message within the software application. The recommendation message constitutes a request from the adopting user or the contributing user to share the recommended calculation configuration. The recommended calculation configuration is referred to as a shared calculation configuration if it is adopted by the second user receiving the recommendation message.

In one or more embodiments, the calculation configuration localization tool (106) includes the calculation configuration sharing manager (108) that is configured to facilitate and track user sharing activities of calculation configurations. In one or more embodiments, the calculation configuration sharing manager (108) is activated in response to the link embedded in the recommendation message. Specifically, when the link is clicked by the aforementioned second user receiving the recommendation message, the second user is re-directed to a server where the calculation configuration sharing manager (108) executes. For example, the calculation configuration sharing manager (108) may execute on the computer server (105a) or some other server separate from the computer server (105a).

In one or more embodiments, the calculation configuration localization tool (106) presents, to the second user and in response to the request to share, the recommended calculation configuration, which may be the suggested calculation configuration or other user created calculation configurations. If the second user adopts the recommended calculation configuration, it is referred to as the shared calculation configuration. Accordingly, the calculation configuration localization tool (106) adds the second user to a network of sharing users. In particular, the calculation configuration localization tool (106) monitors the network of sharing users to track who has used the shared calculation configuration to perform the pre-determined task. If the calculation configuration localization tool (106) detects a revision of the shared calculation configuration by any user in the sharing network, the calculation configuration localization tool (106) sends an alert to the network of sharing users. In one or more embodiments, the alert is sent to those users whose calculation configurations are derived from the revised calculation configuration.

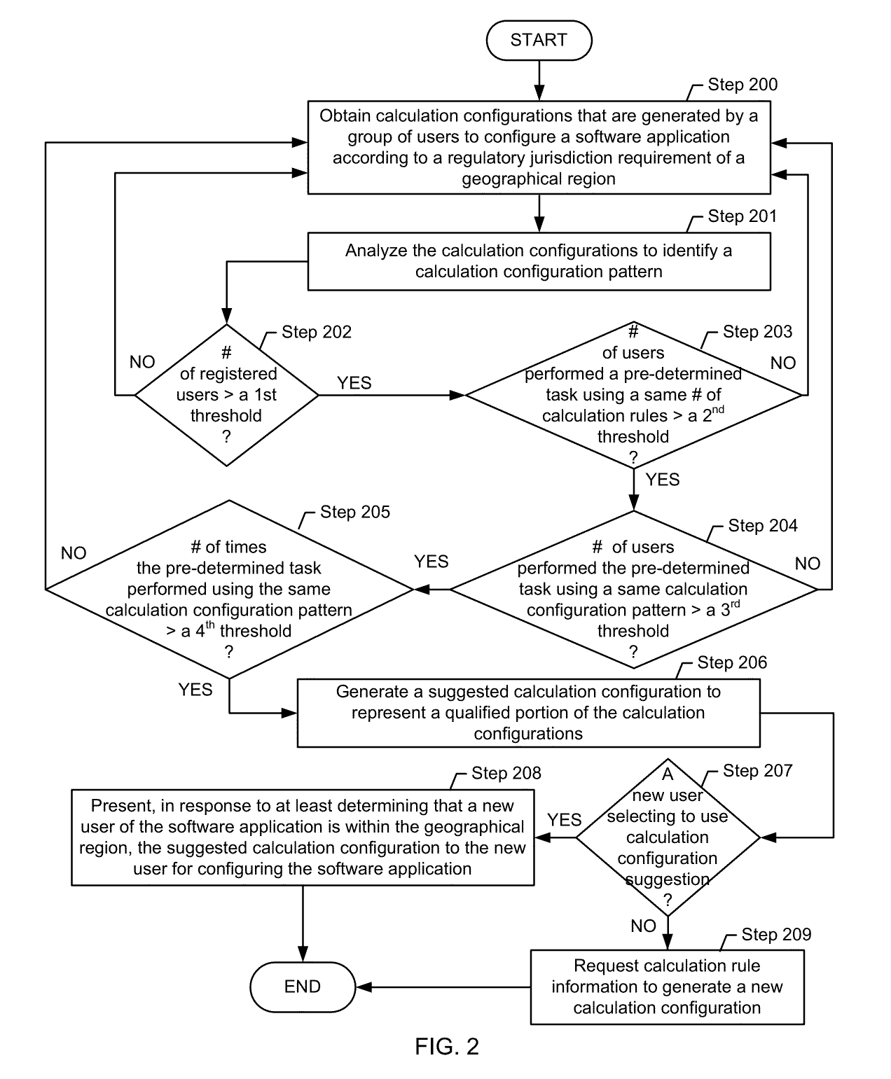

FIG. 2 depicts a flowchart of a method in accordance with one or more embodiments of the invention. In one or more embodiments of the invention, one or more of the steps shown in FIG. 2 may be omitted, repeated, and/or performed in a different order. Accordingly, embodiments of the invention should not be considered limited to the specific arrangements of steps shown in FIG. 2. In one or more embodiments, the method described in reference to FIG. 2 may be practiced using the system (100) described in reference to FIG. 1A above.

Initially in Step 200, calculation configurations of a software application are obtained from a group of users. For example, the software application may be an accounting software, a financial software, a web service, or any other online software product while the calculation configurations may be those described in reference to FIGS. 1A and 1B above. In particular, the software application is used by the group of users to perform a pre-determined task, such as a payroll calculation of a pre-tax deduction amount, a tax withholding amount, and/or a post-tax deduction amount. In one or more embodiments, the calculation configurations are generated by the group of users according to a regulatory requirement of a geographical region. Specifically, each of the calculation configurations includes one or more configuration entries and is used by a user of the group to configure an instantiation of the software application for performing the pre-determined task in compliance with the regulatory requirement. For example, processing a payroll includes calculating the pre-tax deduction amount, the tax withholding amount, and/or the post-tax deduction amount based on one or more configuration entries of the calculation configurations as dictated by the tax jurisdiction.

In one or more embodiments, the group of users is identified based on a total number of configuration entries that is same for each of the calculation configurations. In one or more embodiments, each configuration entry (e.g., row) in a particular calculation configuration is a calculation rule identified by a user defined configuration entry label (i.e., description, or rule name) specific to that particular calculation configuration. In one or more embodiments, the group of users are identified based on a calculation configuration pattern that is the same for each of the calculation configurations, where the calculation configuration pattern includes a sequence of entry elements (i.e., user specified numeric data and user selections of pre-defined text strings) in each configuration entry included in each of the calculation configurations. Generally, a calculation rule is defined by at least the sequence of entry elements. However, different calculation rules may have the same sequences in certain scenarios. In one or more embodiments, the group of users is identified based on an industry designation in a user profile of each user. Said in other words, the group of users is identified such that their calculation configurations all have a same total number of configuration entries and/or a same configuration entry pattern. Further, the group of users may be qualified based on their industry association.

In Step 201, the calculation configurations are analyzed to identify a calculation configuration pattern. For example, the calculation configuration pattern may be one as described in reference to FIGS. 1A and 1B above. In one or more embodiments, it is first determined that every calculation configuration includes a same total number of configuration entries. As noted above, each configuration entry in a particular calculation configuration is identified by a user defined configuration entry label (e.g., “Description” shown in FIG. 1B) specific to that particular calculation configuration.

Because the user defined configuration entry labels (e.g., description, or rule name) are defined based on user discretion, the user defined configuration entry labels from different users, although semantically consistent, may have different wordings. After determining that every calculation configuration includes a same total number of configuration entries, the user defined configuration entry labels (e.g., the aforementioned “Flex Benefits” and “Flexible Benefit”) tagging on same sequence of entry elements (e.g., (PreTax, Single, 5,000, 3%) shown in FIG. 1B) are analyzed to identify their semantic meaning(s). Generally, the configuration entries in these calculation configurations can be categorized based on different semantic meanings of the user defined configuration entry labels.

In one or more embodiments, the user defined configuration entry labels (e.g., description, or rule name) for every configuration entry in these calculation configurations that tag a same sequence of entry elements are analyzed to identify one or more calculation rules. In particular, each calculation rule is described/named by users using user defined configuration entry labels that are semantically equivalent with respect to the regulatory requirement of the geographical region. In one or more embodiments, user specified numeric data and user selections of pre-defined text strings for all calculation rules in a calculation configuration form a calculation configuration pattern.

In one or more embodiments, those calculation configurations sharing the same calculation configuration pattern but having different wordings in their particular user defined configuration entry labels (e.g., description, or rule name) are considered as equivalent calculation configurations. In one or more embodiments, equivalent calculation configurations are represented by a single representative calculation configuration that includes the common calculation configuration pattern where each configuration entry in the common calculation configuration pattern is assigned a system defined configuration entry label. For example, the system defined configuration entry label may be defined based on the equivalent semantic meaning of the user defined configuration entry labels and represent a respective calculation rule dictated by the regulatory requirement of the geographical region. In one or more embodiments, a representative calculation configuration is provided to a new user as a suggested calculation configuration based on certain pre-determined statistical measures described in Steps 202 through 205 below. In particular, these statistical measures relate to the group of users (referred to as the user group) and a number of times the pre-determined task is performed by the group of users.

In Step 202, a determination is made as to whether the number of registered users who have paid for the software application in the user group exceeds a first threshold. If the answer is no, the method returns to Step 200 to collect additional calculation configurations from addition users. If the answer is yes, the method proceeds to Step 203. In one or more embodiments, the number of users in the user group regardless of their registration status may be used as the criterion.

In Step 203, a determination is made as to whether the number of users in the user group who have performed the pre-determined task based on the same number of calculation rules exceeds a second threshold. If the answer is no, the method returns to Step 200 to collect additional calculation configurations from addition users. If the answer is yes, the method proceeds to Step 204.

In Step 204, a determination is made as to whether the number of users in the user group who have performed the pre-determined task based on the same calculation configuration pattern exceeds a third threshold. If the answer is no, the method returns to Step 200 to collect additional calculation configurations from addition users. If the answer is yes, the method proceeds to Step 205.

In Step 205, a determination is made as to whether the number of times that the pre-determined task has been performed by the user group based on the same calculation configuration pattern exceeds a fourth threshold. If the answer is no, the method returns to Step 200 to collect additional calculation configurations from addition users. If the answer is yes, the method proceeds to Step 206.

In Step 206, a suggested calculation configuration is generated to represent a qualified portion of the calculation configurations. Specifically, the qualified portion of the calculation configurations includes those calculation configurations that meet the criterion of the Steps 202 through 205. Said in other words, the aforementioned representative calculation configuration is qualified as the suggested calculation configuration when all criterions in these steps are met.

In Step 207, a determination is made as to whether a new user has selected to use calculation configuration suggestion or not. In particular, the user selection is received when the new user is configuring the software application, for example to process payroll by calculation a pre-tax deduction, a tax deduction, and/or a post-tax deduction. If the answer is no, the method proceeds to Step 209, where a user interface window is presented to the new user requesting calculation rule information for generating a new calculation configuration. If the answer is yes, the method proceeds to Step 208 where the suggested calculation configuration is presented to the new user in response to at least determining that the new user is configuring the software application within the geographical region of the suggested calculation configuration. In this manner, the new user can calculate a pre-tax deduction, a tax deduction, and/or a post-tax deduction for payroll processing in compliance to the regulatory (e.g., tax) jurisdiction of the geographical region.

As described above, the Steps 200 through 208 may be performed separately for user groups in different industries, and performed separately for user groups in different geographical regions regulated by different tax jurisdictions. Accordingly, the process of FIG. 2 may be repeated based on one or more distinctions as described above.

As noted above, a user may allow his/her configuration to be indirectly suggested to other users by the system. Alternatively the user may also directly recommend a calculation configuration that he/she created, adopted, or otherwise has access to. In response to the request to share, the recommended calculation configuration, which may be the suggested calculation configuration or other user created calculation configurations, is presented to the user receiving the recommendation. Accordingly, the user adopting the recommendation is added to a network of sharing users. Upon detecting a revision of the shared calculation configuration by any user in the sharing network, an alert is sent to those users whose calculation configurations are derived from the revised calculation configuration.

FIGS. 3A-3C show an application example in accordance with one or more embodiments of the invention. This application example may be practiced using the system (100) of FIG. 1A and based on the method described with respect to FIG. 2 above.

FIG. 3A shows a screenshot A (300) of a user interface menu in an accounting software. Specifically, the user interface menu allows the new user to configure the calculation configuration before performing any payroll deduction calculations using the accounting software. In the scenario shown in the screenshot A (300), the new user has selected to create a new calculation configuration by activating the command button (303) “ENTER NEW CALCULATION CONFIGURATION.” In response, the bottom panel is displayed requesting the user to enter calculation configuration information (302). As shown, the new user has specified that the entered configuration entry information pertains to “Flex Benefits” calculation rule starting from a particular effective date using the data entry field A (301a) and data entry field B (301b). In addition, the user has specified the “Flex Benefits” calculation rule as a “PreTax” type using the selection menu A (302a). Further, the user has specified the “Flex Benefits” calculation rule as for a “Single” filing status using the selection menu B (302b). Still further, the user has entered numerical data 5,000 and 3% under the “Amount” and “Emp %” columns for the “Flex Benefits” calculation rule using additional data entry fields (e.g., additional data entry fields (301c)). Other user created calculation rules in the rest of rows are specified by the user using the data entry field A (301a), the selection menu A (302a), and the selection menu B (302b) in a similar manner. Specifically, the user created calculation rules in these nine configuration entries (i.e., nine rows) shown in FIG. 3A correspond to the example calculation configuration (150) shown in FIG. 1B above.

As noted above, the users have the option to invite others to leverage the calculation configurations that they have set up in the software application. Specifically, the user may click on “Sharing Network A” (306a) or “Sharing Network B (306b) to send recommendation messages. For example, the sharing network A is a social network and the recommendation message may be posted on the user's social network page for viewing by the user's social network friends. In another example, the sharing network B is an email recipient list and the recommendation message may be sent to every one on the user's email recipient list. An example recommendation message may be the following: “I have set up the payroll calculation configuration for country X. Please click here <suggested configuration> to get started to use my setup.” When other users (e.g., user's social network friends or email list recipients) click on the link <suggested configuration>, the software application server copies of the payroll calculation configuration over to the new user's copy (i.e., instantiation). In addition, the software application server informs the original user on who is planning to start using his/her recommended configuration. Further, a link is established between the two users and displayed on the setting pages of their respective software application copies.

In a different scenario, the new user may select to adopt a system suggested calculation configuration by activating the command button (304) “USE SUGGESTED CALCULATION CONFIGURATION.” In response, the new user is presented with a selection menu (305a) shown in FIG. 3B instead of the bottom panel requesting calculation configuration information (302).

FIG. 3B shows the selection menu (305a) where the new user may select one of two suggested calculation configurations that are suggested based on the new user's tax jurisdiction (i.e., Country X). As shown, the first suggested calculation configuration of the two selections has been used by 50 companies in the country X to process 2635 payroll runs. In addition, the second suggested calculation configuration of the two selections has been used by 300 companies in the country X to process 800 payroll runs. In each of the two selections, the new user may view the calculation configuration by clicking on the command button labeled “Details.” Accordingly, a graphical representation or other details such as the example calculation configuration (150) shown in FIG. 1B may be presented to the new user. The selection menu (305a) may further include data entry fields and command buttons allowing the new user to provide feedback and rate the system suggested calculation configurations.

After the new user has adopted one of the suggested calculation configurations, the new user may receive a notification alert that the adopted calculation configuration may have been recently updated by other users in the same tax jurisdiction. The alert message window (310) shows an example of such notification where the user may review the changes by activating the command button labeled “Review Details” or adopt the updated calculation configuration by activating the command button labeled “Apply Changes.”

FIG. 3C shows an example network of sharing users. As shown in FIG. 3C, nodes 1 through 10 represents user 1 through user 10 of the software application, such as accountants and/or small business owners. The arrows represent sharing relationships among these users within a Calculation Configuration Sharing Network (120). For example, the user 2, user 3, and user 8 have adopted the recommended calculation configuration from the user 1. In turn, the user 2 has further recommended it to user 4 and user 5. User 3 has further recommended it to user 6 who recommends it to user 7, user 9, and user 10. In this scenario, if user 6 revises his adopted calculation configuration, then user 7, user 9, and user 10 will receive an alert. However, if user 1 revises his calculation configuration, all other users will receive an alert.

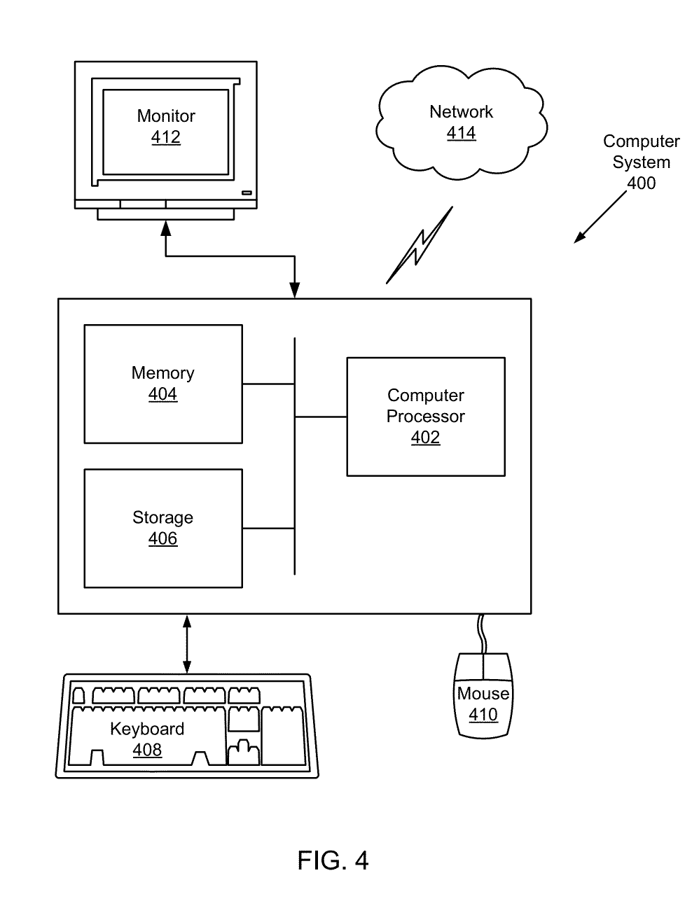

Embodiments of the invention may be implemented on virtually any type of computer regardless of the platform being used. For example, as shown in FIG. 4, a computer system (400) includes one or more computer processor(s) (402) such as a central processing unit (CPU), integrated circuit, or other hardware processor, associated memory (404) (e.g., random access memory (RAM), cache memory, flash memory, etc.), a storage device (406) (e.g., a hard disk, an optical drive such as a compact disk drive or digital video disk (DVD) drive, a flash memory stick, etc.), and numerous other elements and functionalities typical of today's computers (not shown). The computer system (400) may also include input means, such as a keyboard (408), a mouse (410), or a microphone (not shown). Further, the computer system (400) may include output means, such as a monitor ((412) (e.g., a liquid crystal display (LCD), a plasma display, or cathode ray tube (CRT) monitor). The computer system (400) may be connected to a network (414) (e.g., a local area network (LAN), a wide area network (WAN) such as the Internet, or any other similar type of network)) with wired and/or wireless segments via a network interface connection (414). Those skilled in the art will appreciate that many different types of computer systems exist, and the aforementioned input and output means may take other forms. Generally speaking, the computer system (400) includes at least the minimal processing, input, and/or output means necessary to practice embodiments of the invention.

Further, those skilled in the art will appreciate that one or more elements of the aforementioned computer system (400) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions for performing embodiments of the invention may be stored on a non-transitory computer readable storage medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to generate a suggested calculation configuration in a software application for a geographical region, comprising:
obtaining a plurality of calculation configurations generated by a plurality of users according to a regulatory requirement of the geographical region,
wherein each of the plurality of calculation configurations comprises a configuration entry that is used by the plurality of users to configure a plurality of instantiations of the software application for performing a pre-determined task, and
wherein performing the pre-determined task within the geographical region comprises at least calculating a result based on the configuration entry;
generating, by a computer processor, a statistical measure of the plurality of users and a number of times the pre-determined task is performed by the plurality of users;
generating, by the computer processor and in response to the statistical measure exceeding a pre-determined threshold, a suggested calculation configuration to represent the plurality of calculation configurations; and
presenting, in response to at least determining that a new user of the software application is within the geographical region, the suggested calculation configuration to the new user, wherein the suggested calculation configuration is used by the new user to configure a new instantiation of the software application for performing the pre-determined task within the geographical region.

2. The method of claim 1,
wherein the software application comprises a payroll software application,
wherein the calculation configuration comprises a payroll calculation configuration, and
wherein performing the pre-determined task within the geographical region further comprises generating, based on the regulatory requirement, at least one selected from a group consisting of a pre-tax deduction amount, a tax withholding amount, and a post-tax deduction amount.

3. The method of claim 1, wherein the statistical measure comprises a number of registered users who have paid for the software application.

4. The method of claim 1, further comprising:
identifying the plurality of users based on a calculation configuration pattern that is same for each of the plurality of calculation configurations,
wherein the calculation configuration pattern comprises a pattern of all entry elements of all configuration entries in each of the plurality of calculation configurations, and
wherein the statistical measure comprises a number of users among the plurality of users who have performed the pre-determined task based on the calculation configuration pattern.

5. The method of claim 1, further comprising:
identifying the plurality of users based on a calculation configuration pattern that is same for each of the plurality of calculation configurations,
wherein the calculation configuration pattern comprises a pattern of all entry elements of all configuration entries in each of the plurality of calculation configurations, and
wherein the statistical measure comprises a number of times that the plurality of users have performed the pre-determined task based on the calculation configuration pattern.

6. The method of claim 1, further comprising:
analyzing the plurality of calculation configurations to identify a calculation configuration pattern by:
determining that every calculation configuration of the plurality of calculation configurations comprises a same number of configuration entries, wherein each configuration entry is labeled in a particular calculation configuration of the plurality of calculation configurations by a user defined label specific to the particular calculation configuration, and
analyzing, in response to the determining, the user defined label for every configuration entry in the plurality of calculation configurations that has a same sequence of entry elements to identify a plurality of calculation rules,
wherein each of the plurality of calculation rules is labeled by a plurality of user defined labels that are semantically equivalent with respect to the regulatory requirement of the geographical region and identify equivalent configuration entries in the plurality of calculation configurations,
wherein each of the plurality of user defined labels that are semantically equivalent is specific to one of the plurality of calculation configurations,
wherein the calculation configuration pattern comprises a plurality of sequences of entry elements corresponding to the plurality of calculation rules,
wherein the statistical measure is based at least on the calculation configuration pattern, and
wherein the suggested calculation configuration comprises the calculation configuration pattern and a system defined label for each of the plurality of calculation rules to represent a respective requirement dictated by the regulatory requirement of the geographical region.

7. The method of claim 6,
wherein the determining is based on comparing every calculation configuration within each of a plurality of subsets of the plurality of calculation configurations, wherein the plurality of subsets comprise a pre-tax subset, a tax subset, and a post-tax subset, and
wherein the analyzing is based on comparing every user defined label within each of a plurality of subsets of the plurality of calculation configurations.

8. The method of claim 6, wherein the statistical measure comprises:
a number of registered users who have paid for the software application;
a number of users among the plurality of users who have performed the pre-determined task based on the calculation configuration pattern; and
a number of times that the plurality of users has performed the pre-determined task based on the calculation configuration pattern.

9. The method of claim 6, further comprising:
generating, based at least on another calculation configuration pattern, another statistical measure of another plurality of users and another number of times the pre-determined task is performed by the another plurality of users, wherein the calculation configuration pattern and the another calculation configuration pattern correspond to a first user industry and a second user industry, respectively;
generating, in response to the another statistical measure exceeding the pre-determined threshold, another suggested calculation configuration based on the another calculation configuration pattern; and
presenting, in response to at least determining that another new user of the software application is associated with the second user industry, the another suggested calculation configuration to the another new user, wherein the another suggested calculation configuration is used by the another new user to configure another new instantiation of the software application for performing the pre-determined task.

10. The method of claim 1, further comprising:
obtaining another plurality of calculation configurations generated by another plurality of users according to another regulatory requirement of another geographical region, wherein each of the another plurality of calculation configurations comprises another configuration entry that is used by the another plurality of users to configure another plurality of instantiations of the software application for performing the pre-determined task, wherein performing the pre-determined task within the another geographical region comprises at least calculating another result based on the another configuration entry;
generating another statistical measure of the another plurality of users and another number of times the pre-determined task is performed by the another plurality of users;
generating, in response to the another statistical measure exceeding the pre-determined threshold, another suggested calculation configuration to represent another portion of the another plurality of calculation configurations; and
presenting the another suggested calculation configuration to the another new user of the software application, wherein the another suggested calculation configuration is used by the another new user to configure another new instantiation of the software application for performing the pre-determined task within the another geographical region.

11. The method of claim 1, wherein generating the plurality of calculation configurations by the plurality of users comprises:
receiving, by an instantiation of the plurality of instantiations to perform the pre-determined task, an input from a user of the plurality of users to select between manually creating a new calculation configuration or using a calculation configuration suggestion function of the software application; and
generating, by the instantiation of the software application and in response to the user selecting to manually create the new calculation configuration, one of the plurality of calculation configurations based on further inputs from the user,
wherein presenting the suggested calculation configuration to the new user is in response to the new user selects to use the calculation configuration suggestion function.

12. The method of claim 1, further comprising:
presenting, to another new user and in response to a request from at least one user of the new user and the plurality of the users, a shared calculation configuration selected from the suggested calculation configuration and the plurality of calculation configurations;
adding, in response to the another new user adopting the shared calculation configuration, the another new user to a network of sharing users who have used the shared calculation configuration to perform the pre-determined task; and
sending, in response to detecting a revision of the shared calculation configuration, an alert to the network of sharing users.

13. The method of claim 12,
wherein the another new user receives, from the at least one user, a social network message comprising a link referencing the shared calculation configuration, and
wherein the shared calculation configuration is presented to the another new user via the link.

14. A system to generate a suggested calculation configuration in a software application for a geographical region, comprising:
a computer processor;
a calculation configuration analyzer executing on the computer processor and configured to:
obtain a plurality of calculation configurations generated by a plurality of users according to a regulatory requirement of the geographical region,
wherein each of the plurality of calculation configurations comprises a configuration entry that is used by the plurality of users to configure a plurality of instantiations of the software application for performing a pre-determined task, and wherein performing the pre-determined task within the geographical region comprises at least calculating a result based on the configuration entry;
generate a statistical measure of the plurality of users and a number of times the pre-determined task is performed by the plurality of users;
generate, in response to the statistical measure exceeding a pre-determined threshold, a suggested calculation configuration to represent the plurality of calculation configurations;
a user device coupled to the computer processor and configured to:
present, in response to at least determining that a new user of the software application is within the geographical region, the suggested calculation configuration to the new user, wherein the suggested calculation configuration is used by the new user to configure a new instantiation of the software application for performing the pre-determined task within the geographical region; and
a repository configured to store the statistical measure and the suggested calculation configuration.

15. The system of claim 14,
wherein the software application comprises a payroll software application,
wherein the calculation configuration comprises a payroll calculation configuration, and
wherein performing the pre-determined task within the geographical region further comprises generating, based on the regulatory requirement, at least one selected from a group consisting of a pre-tax deduction amount, a tax withholding amount, and a post-tax deduction amount.

16. The system of claim 14, wherein the statistical measure comprises a number of registered users who have paid for the software application.

17. The system of claim 14, wherein the calculation configuration analyzer is further configured to:
identify the plurality of users based on a calculation configuration pattern that is same for each of the plurality of calculation configurations,
wherein the calculation configuration pattern comprises a pattern of all entry elements of all configuration entries in each of the plurality of calculation configurations, and
wherein the statistical measure comprises a number of users among the plurality of users who have performed the pre-determined task based on the calculation configuration pattern.

18. The system of claim 14, wherein the calculation configuration analyzer is further configured to:
identify the plurality of users based on a calculation configuration pattern that is same for each of the plurality of calculation configurations,
wherein the calculation configuration pattern comprises a pattern of all entry elements of all configuration entries in each of the plurality of calculation configurations, and
wherein the statistical measure comprises a number of times that the plurality of users have performed the pre-determined task based on the calculation configuration pattern.

19. The system of claim 14, wherein the calculation configuration analyzer is further configured to analyze the plurality of calculation configurations to identify a calculation configuration pattern by:
determining that every calculation configuration of the plurality of calculation configurations comprises a same number of configuration entries, wherein each configuration entry is labeled in a particular calculation configuration of the plurality of calculation configurations by a user defined label specific to the particular calculation configuration; and
analyzing, in response to the determining, the user defined label for every configuration entry in the plurality of calculation configurations that has a same sequence of entry elements to identify a plurality of calculation rules,
wherein each of the plurality of calculation rules is labeled by a plurality of user defined labels that are semantically equivalent with respect to the regulatory requirement of the geographical region and identify equivalent configuration entries in the plurality of calculation configurations,
wherein each of the plurality of user defined labels that are semantically equivalent is specific to one of the plurality of calculation configurations,
wherein the calculation configuration pattern comprises a plurality of sequences of entry elements corresponding to the plurality of calculation rules,
wherein the statistical measure is based at least on the calculation configuration pattern, and
wherein the suggested calculation configuration comprises the calculation configuration pattern and a system defined label for each of the plurality of calculation rules to represent a respective requirement dictated by the regulatory requirement of the geographical region.

20. The system of claim 19,
wherein the determining is based on comparing every calculation configuration within each of a plurality of subsets of the plurality of calculation configurations, wherein the plurality of subsets comprise a pre-tax subset, a tax subset, and a post-tax subset, and
wherein the analyzing is based on comparing every user defined label within each of a plurality of subsets of the plurality of calculation configurations.

21. The system of claim 19, wherein the statistical measure comprises:
a number of registered users who have paid for the software application;
a number of users among the plurality of users who have performed the pre-determined task based on the calculation configuration pattern; and
a number of times that the plurality of users has performed the pre-determined task based on the calculation configuration pattern.

22. The system of claim 19, wherein the calculation configuration analyzer is further configured to:
generate, based at least on another calculation configuration pattern, another statistical measure of another plurality of users and another number of times the pre-determined task is performed by the another plurality of users, wherein the calculation configuration pattern and the another calculation configuration pattern correspond to a first user industry and a second user industry, respectively; and
generate, in response to the another statistical measure exceeding the pre-determined threshold, another suggested calculation configuration based on the another calculation configuration pattern; and
wherein the system further comprises another user device configured to present, in response to at least determining that another new user of the software application is associated with the second user industry, the another suggested calculation configuration to the another new user, wherein the another suggested calculation configuration is used by the another new user to configure another new instantiation of the software application for performing the pre-determined task.

23. The system of claim 14, wherein the calculation configuration analyzer is further configured to:
obtain another plurality of calculation configurations generated by another plurality of users according to another regulatory requirement of another geographical region, wherein each of the another plurality of calculation configurations comprises another configuration entry that is used by the another plurality of users to configure another plurality of instantiations of the software application for performing the pre-determined task, wherein performing the pre-determined task within the another geographical region comprises at least calculating another result based on the another configuration entry;
generate another statistical measure of the another plurality of users and another number of times the pre-determined task is performed by the another plurality of users;
generate, in response to the another statistical measure exceeding the pre-determined threshold, another suggested calculation configuration to represent another portion of the another plurality of calculation configurations; and
wherein the system further comprises another user device configured to present the another suggested calculation configuration to the another new user of the software application, wherein the another suggested calculation configuration is used by the another new user to configure another new instantiation of the software application for performing the pre-determined task within the another geographical region.

24. The system of claim 14, wherein generating the plurality of calculation configurations by the plurality of users comprises:
receiving, by an instantiation of the plurality of instantiations to perform the pre-determined task, an input from a user of the plurality of users to select between manually creating a new calculation configuration or using a calculation configuration suggestion function of the software application; and
generating, by the instantiation of the software application and in response to the user selecting to manually create the new calculation configuration, one of the plurality of calculation configurations based on further inputs from the user,
wherein presenting the suggested calculation configuration to the new user is in response to the new user selects to use the calculation configuration suggestion function.

25. The system of claim 14, further comprising:
a calculation configuration sharing manager executing on the computer processor and configured to:
present, to another new user and in response to a request from at least one user of the new user and the plurality of the users, a shared calculation configuration selected from the suggested calculation configuration and the plurality of calculation configurations;
add, in response to the another new user adopting the shared calculation configuration, the another new user to a network of sharing users who have used the shared calculation configuration to perform the pre-determined task; and
send, in response to detecting a revision of the shared calculation configuration, an alert to the network of sharing users.

26. The system of claim 25,
wherein the another new user receives, from the at least one user, a social network message comprising a link referencing the shared calculation configuration, and
wherein the shared calculation configuration is presented to the another new user via the link.

27. A non-transitory computer readable medium storing instructions to generate a suggested calculation configuration in a software application for a geographical region, the instructions, when executed by a computer processor, comprising functionality for:
obtaining a plurality of calculation configurations generated by a plurality of users according to a regulatory requirement of the geographical region,
wherein each of the plurality of calculation configurations comprises a configuration entry that is used by the plurality of users to configure a plurality of instantiations of the software application for performing a pre-determined task, and
wherein performing the pre-determined task within the geographical region comprises at least calculating a result based on the configuration entry;
generating, by a computer processor, a statistical measure of the plurality of users and a number of times the pre-determined task is performed by the plurality of users;
generating, by the computer processor and in response to the statistical measure exceeding a pre-determined threshold, a suggested calculation configuration to represent the plurality of calculation configurations; and
presenting, in response to at least determining that a new user of the software application is within the geographical region, the suggested calculation configuration to the new user, wherein the suggested calculation configuration is used by the new user to configure a new instantiation of the software application for performing the pre-determined task within the geographical region.
